(19) United States
(12) Patent Application Publication
(10) Pub. No.: US 2019/0282936 A1
(43) Pub. Date: Sep. 19, 2019

(54) FILTER DEVICE

(71) Applicant: Mahle International GmbH, Stuttgart (DE)

(72) Inventors: Denis Hofmann, Stuttgart (DE); Andreas Kollmann, Eitweg (AT); Patrick Wieler, Urbach (DE)

(21) Appl. No.: 16/347,341

(22) PCT Filed: Sep. 4, 2017
(86) PCT No.: PCT/EP2017/072105

§ 371 Date: May 3, 2019

(30) Foreign Application Priority Data
Nov. 4, 2016 (DE) 10 2016 221 686.4

(51) Int. Cl. B01D 29/21; B01D 29/96; B01D 35/16; B01D 35/30

(52) U.S. Cl. CPC B01D 29/21; B01D 29/96; B01D 35/16; B01D 35/30; B01D 2201/4053; B01D 2201/301; B01D 2201/347; B01D 2201/4007; B01D 2201/295

(57) ABSTRACT

A filter device may include a filter housing pot and a ring filter element arranged therein. The filter housing pot may have a central drain channel in which an adjustable drain screw having a driver contour is arranged. The ring filter element may include a lower end disk and may interact with the filter housing pot via a counter-driver contour interacting with the driver contour. In a lower position the drain screw may close the drain channel. In an intermediate position the drain screw may free the drain channel and does not interact with the counter-driver contour via the driver contour. In an upper position the drain screw may free the drain channel and interact with the counter-driver contour via the driver contour. The drain screw and the ring filter element may be configured such that a twisting of the drain screw twists the ring filter element.

### CROSS-REFERENCE TO RELATED APPLICATIONS

This application claims priority to International Patent Application No. PCT/EP2017/072105 filed on Sep. 4, 2017, and to German Patent Application No. DE 10 2016 221 686.4 filed on Nov. 4, 2016, the contents of each of which are here by incorporated by reference in their entirety.

### TECHNICAL FIELD

The present invention relates to a filter device having a filter housing pot. The invention furthermore relates to a ring filter element for such a filter device.

### BACKGROUND

Generic filter devices are sufficiently and diversely known.

From DE 197 07 132 A1 a filter device is known with a housing having a filter housing pot and a cover which is able to be screwed therewith, and with a ring filter element arranged therein, wherein at least one detent means is provided, by means of which a detachable detent connection is able to be produced between the filter element and at least one of the housing parts. Hereby, it is to be made possible in particular to mount or respectively dismantle the ring filter element more easily without, in so doing, having to come in direct contact with the filter element.

From DE 10 2012 00 876 C5 a liquid filter of an internal combustion engine is known, with a filter housing, which is connected to a liquid directing system. A housing pot is connected here with a housing cover via a housing/cover connection, wherein this connection can be locked and unlocked by means of a housing rotational movement of the housing pot relative to the housing cover about an imaginary mounting axis. A filter element is connected to the housing cover via an element/cover connection. The two connections are coordinated with one another here in such a way that on a rotational movement of the housing pot relative to the housing cover, for opening or closing the connection there, this rotational movement is transferred to the filter element by means of the element/housing connection, so that the filter element can be rotated together with the housing pot relative to the housing cover. As the closing direction of the housing/cover connection corresponds to the opening direction of the element/cover connection, on locking of the housing/cover connection the element/cover connection can be automatically unlocked, in so far as this was previously locked. Hereby, in particular also a filter element exchange which conserves resources can be made possible.

From DE 10 2008 011 616 A1 a filter housing is known which extends along a longitudinal axis and comprises two housing parts connected detachably to one another. The connection of the two housing parts is detachable by rotation of the one housing part in a rotation direction about the longitudinal axis relative to the other housing part. Furthermore, an anti-rotation means is provided for the two housing parts with respect to one another, with an actuating lever which is embodied in one piece with its lever axis and materially integrally with a wall of one of the two housing parts. Hereby, it is to be possible to mount or respectively dismantle the cover more easily.

From EP 2 468 378 A1 a generic filter device is known with a filter housing pot and with a ring filter element arranged therein.

In fuel- or respectively lubricant filters, in particular in large ring filter elements, such as for example in utility vehicle filters, great frictional forces occur between sealing rings and sealing surfaces. Through the swelling and adhering of the sealing rings during operation, these forces can be additionally intensified. Hereby, in the case of servicing, it can occur that the conventional holding forces of a clip connection between a cover and the ring filter element are not sufficient to also extract the latter from the filter housing pot on loosening of the cover, so that it remains therein and has to be removed manually therefrom laboriously.

### SUMMARY

The present invention is therefore concerned with the problem of indicating for a filter device of the generic type an improved or at least an alternative embodiment, which in particular is more maintenance-friendly.

This problem is solved according to the invention by the subject of the independent claim(s). Advantageous embodiments are the subject of the dependent claim(s).

The present invention is based on the general idea of simplifying an exchange of a ring filter element in a filter device, in that a seal which is adhered, under certain circumstances, during the operation of the filter device, is already detached from the filter device before the actual dismantling of the ring filter element. For this, according to the invention, a drain screw is used, which therefore fulfils not only the function of a water drain or respectively a draining of filter liquid before the exchange of the ring filter element, but rather additionally also constitutes a dismantling aid for the ring filter element. The filter device according to the invention has a filter housing having a filter housing pot and a cover able to be screwed therewith, with the ring filter element arranged therein. The filter housing pot has a central drain channel in which the previously mentioned drain screw is arranged. According to the invention, this drain screw has a driver contour. The ring filter element inserted into the filter housing and in particular into the filter housing pot has a lower end disk with a ring seal lying on the outside and, in the installed state, interacting with the filter housing pot, and with a counter-driver contour interacting with the driver contour of the drain screw. According to the invention, the drain screw is now adjustable between at least three positions, namely a lower position, in which the drain screw tightly closes the drain channel, wherein the lower position constitutes the operating position. The second position is an intermediate position, in which the drain screw frees the drain channel, but does not yet interact via its driver contour with the counter-driver contour on the ring filter element side or respectively on the end disk side. In this intermediate position therefore a draining is possible of, for example, water accumulated at the bottom in the filter device. The third position of the drain screw is an upper position, in which the drain screw frees both the drain channel and also interacts, via its driver contour, with the counter-driver contour on the ring filter element side, whereby a twisting of the drain screw simultaneously also causes a twisting of the ring filter element and, in so doing, a detaching of the ring seal of the lower end disk of the ring filter element which under certain circumstances is adhered to the filter housing pot. According to the invention, therefore, two functions are intended for the drain screw, namely on the one hand the draining of, for example, separated water or else of the filter liquid for the exchange of the ring filter element, and on the other hand the twisting of the ring filter element, whereby the latter is detached from the filter housing pot in the region of its ring seal which is arranged externally on the lower end disk.

The exchange of the ring filter element from the filter device according to the invention can take place here for example as follows: Firstly the drain screw is adjusted from its lower position into the intermediate position and via the latter into its upper position, wherein already in the intermediate position a draining takes place of liquid present in the filter housing. By a transferring of the drain screw into its upper position, at the same time also a twisting of the ring filter element takes place, whereby the ring seal, arranged between the latter and the filter housing, detaches itself from the filter housing pot. Subsequently, the filter housing pot, which is screwed with the cover by means of a screw connection, can be unscrewed, wherein subsequently by a further rotating of the drain screw the ring filter element is also rotated and at the same time is pressed out from the filter housing pot. The terms “filter housing pot” and “cover” can of course also be used in reverse, in particular for the case where the filter device concerns a standing filter.

In an advantageous further development of the solution according to the invention, the driver contour on the drain screw side has at least two, in particular axially and/radially projecting wings, wherein the counter-driver contour has at least two stop elements which in the upper position of the drain screw interact with the wings of the driver contour on the drain screw side. The at least two wings of the driver contour on the drain screw side cause here, on the one hand, the drain screw situated in its upper position, an axial pressing against the ring filter element and also a twisting thereof via an abutting of the wings against the associated stop elements. Through the in particular axially and/or radially projecting embodiment, an elastic axial prestressing of the wings against the lower end disk of the ring filter element can take place.

In a further advantageous embodiment of the solution according to the invention, the ring filter element is connected with the filter housing pot via a first thread. Here, a dome, projecting centrically and axially from the lower end disk of the ring filter element, with an external thread which is interrupted by clearances, and hollow-cylindrically arranged spring elements projecting axially from the filter housing pot are provided, at which respectively an internal thread portion, formed in a complementary manner to the external thread, is arranged, wherein the internal thread and the external thread together form the first thread. Each internal thread portion extends here over a longer circumferential portion than a clearance. The first thread is, in addition, formed in the opposite direction to a second thread arranged between the filter housing pot and the drain screw. Through the first and second threads arranged in opposite direction, it is particularly easy to also mount or respectively dismantle comparatively large ring filter elements, for example for utility vehicles. On mounting, firstly here the ring filter element is screwed in the filter housing pot, wherein this screwing is possible with few rotational movements owing to the clearances provided in the external thread of the ring filter element. Subsequently, the thus pre-mounted assembly can be screwed with the cover. The dismantling takes place here as described in the previous paragraph.

In a further advantageous embodiment of the solution according to the invention, a total of eight spring elements are provided with respectively an internal thread portion. Additionally or alternatively, the external thread can have a total of six clearances. This specific embodiment of the external thread and of the internal thread portion makes possible both a reliable and easy mounting and also, in the same manner, a reliable and easy dismantling, in which in each case it can be ensured that even in the case of swollen seals and thereby high retention forces between the ring filter element and the filter housing pot, the ring filter element can be extracted reliably from the filter housing pot.

Expediently, the dome and the external thread with its clearances are formed in one piece with the lower end disk. Here, it presents itself to form the lower end disk together with the dome and the external thread as a favourably priced plastic injection moulded part.

The present invention is based furthermore on the general idea of indicating a ring filter element for such a previously described filter device, with a dome projecting centrically axially from a lower end disk, said dome having an external thread interrupted by clearances. Through the specific configuration of the internal thread portion and of the external thread, a type of key/lock principle can also be realized, which forces the use of an authorized ring filter element, whereby in particular a long-term first-class filter performance can be guaranteed.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown here, respectively diagrammatically,

FIG. 1 shows a sectional illustration, through a filter device according to the invention, with drain screw situated in its lower position,

FIG. 2 shows an illustration as in FIG. 1, but with drain screw in section at the same time,

FIG. 3 shows an illustration as in FIG. 2, but with drain screw situated in its intermediate position,

FIG. 4 shows an illustration as in FIG. 2, but with drain screw situated in its upper position,

FIG. 5 shows a view from below onto a ring filter element with corresponding drivers,

FIG. 6 shows a view from above onto the drain screw with corresponding drivers,

FIG. 7 shows the components shown according to FIGS. 5 and 6, in operative connection.

### DETAILED DESCRIPTION

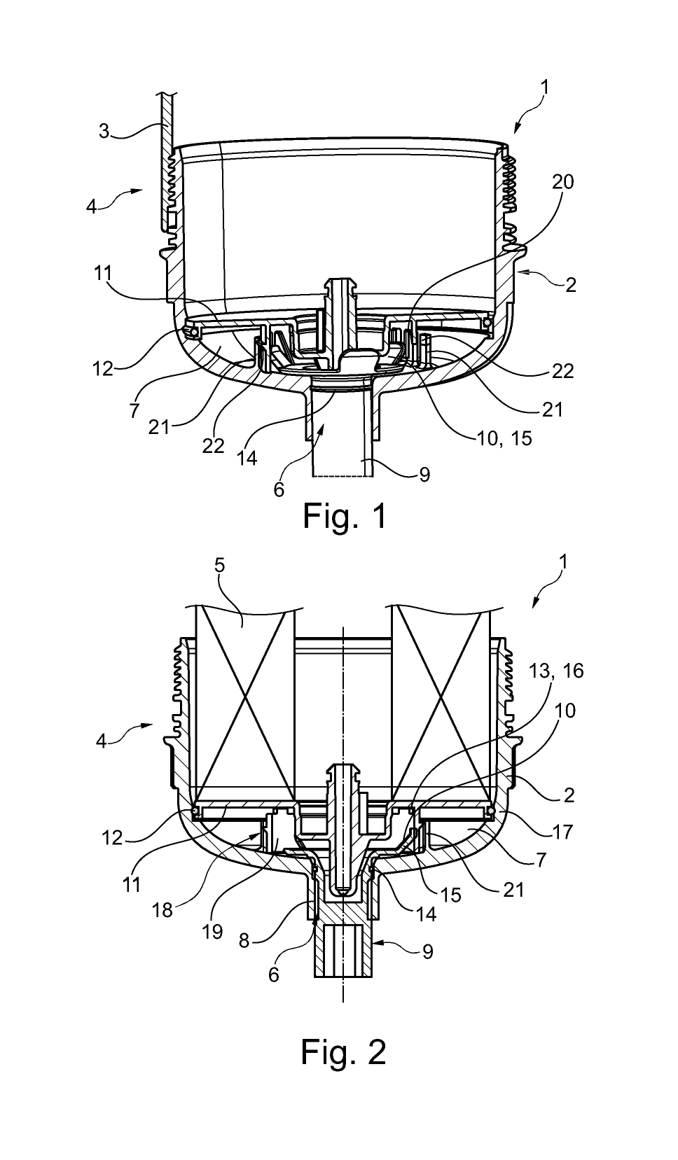

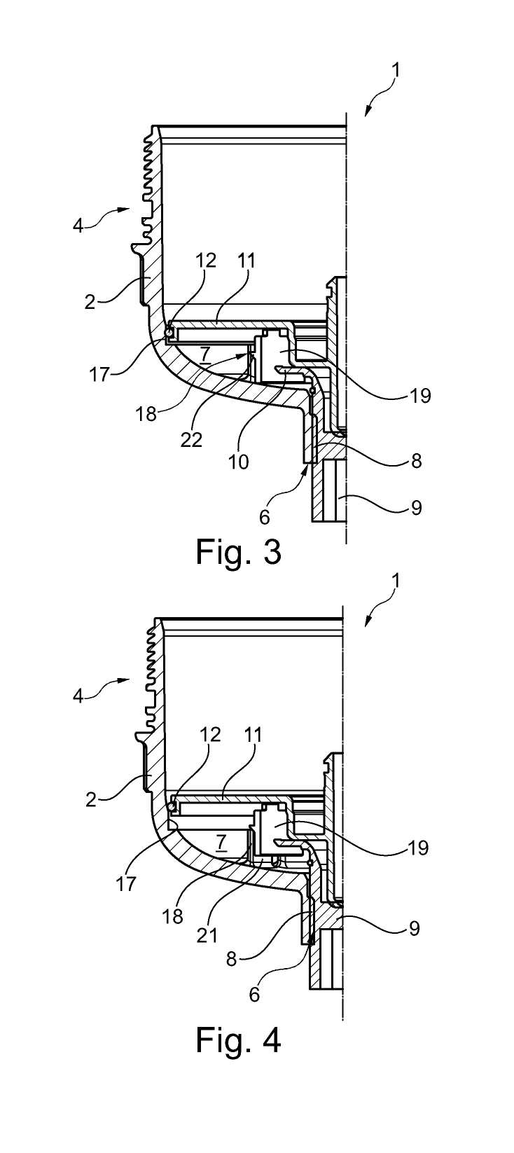

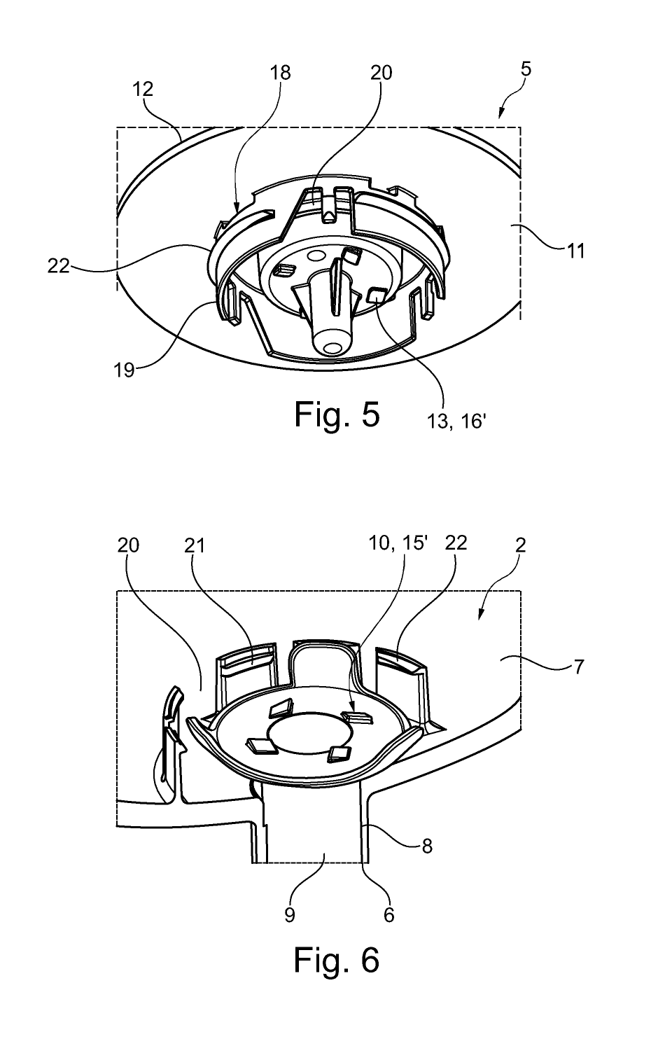

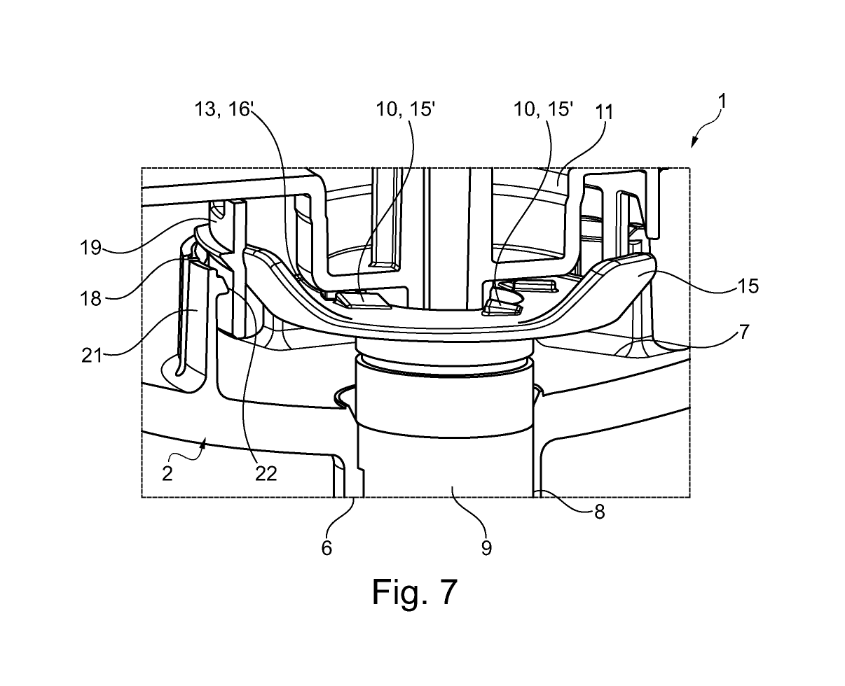

According to FIGS. 1 to 4, a filter device 1 according to the invention, which can be configured for example as an oil or fuel filter, has a filter housing pot 2 and a cover 3 which is able to be screwed therewith and is merely indicated in FIG. 1. Together, these form a filter housing 4. In the filter housing 4 a ring filter element 5 (cf. FIG. 2) is arranged. The filter housing pot 2 has here a central drain channel 6, via which both accumulated water in a water collecting chamber 7 and also the entire liquid in the filter housing pot 2 can be drained in the case of a pending filter change (cf. also FIGS. 6 and 7). In the drain channel 6 a drain screw 9, rotatable about a second thread 8, is arranged, which drain screw has a driver contour 10. The ring filter element 5 has a lower end disk 11 with a ring seal 12 lying on the outside and, in the installed state, interacting with the filter housing pot 2, and with a counter-driver contour 13 (cf. FIG. 5) interacting with the driver contour 10. The drain screw 9 is adjustable here between at least three positions, as is illustrated according to FIGS. 1 to 4, namely between a lower position (cf. FIGS. 1 and 2), in which the drain screw 9 tightly closes the drain channel 6, an intermediate position (cf. FIG. 3), in which the drain screw 9 frees the drain channel 6, but does not yet interact via its driver contour 10 with the counter-driver contour 13 on the ring filter element side, and finally an upper position (cf. FIGS. 4, 7), in which the drain screw 9 frees the drain channel 6 and interacts via its driver contour 10 with the counter-driver contour 13 on the ring filter element side, whereby a twisting of the drain screw 9 also causes, at the same time, a twisting of the ring filter element 5.

In the lower position, the drain screw 9 therefore tightly closes the drain channel 6 via a ring seal 14. In the intermediate position, as is illustrated according to FIG. 3, the drain screw 9 is already adjusted so far upwards that the seal 14 is no longer arranged tightly in the drain channel 6 and in this state therefore a draining of, for example, water can take place out from the water collecting chamber 7. In the upper position likewise a draining of water or respectively liquid can take place via the drain channel 6, wherein simultaneously with a twisting of the drain screw 9 in its upper position via the driver contour 10 and counter-driver contour 13, interacting in this case, a twisting of the ring filter element 5 and thereby also a detaching of the ring seal 12 also takes place. The ring seal 12 seals, for example, the water collecting chamber 7, arranged therebeneath, from a raw or clean chamber arranged thereabove, and is clamped elastically between the lower end disk 11 and the filter housing pot 2. During the operation of the filter device 1, a swelling and also an adhering of the ring seal 12 with the lower end disk 11 and with the filter housing pot 2 can occur, whereby a detaching and extracting of the ring filter element 5 out from the filter housing pot 2 is made difficult in the event of a desired exchange. It can be counteracted by the drain screw 9 according to the invention, because this makes possible not only the function of the water or respectively liquid drain, but in addition, via its driver contour 10, also a twisting and therefore a detaching of the ring filter element 5 and, at the same time, also an axial adjustment thereof, as is illustrated according to FIG. 4.

Observing the driver contour 10 on the drain screw side according to FIGS. 1 to 4, it can be seen that this has at least two, in particular axially and/or radially projecting, wings 15. The counter-driver contour 13 has at least two stop elements 16, which in the upper position of the drain screw 9 interact with the wings 15 of the driver contour 10 on the drain screw side, and on a twisting of the drain screw 9 in the upper position at the same time also cause a twisting of the ring filter element 5.

Observing the driver contour 10 on the drain screw side according to FIGS. 6 and 7, it can be seen that this has at least two, in particular axially projecting, wedge-shaped drivers 15′, whilst the counter-driver contour 13 has at least two, likewise wedge-shaped, drivers 16′ (cf. FIG. 5), which in the upper position of the drain screw 9 interact with the drivers 15′ of the driver contour 10 on the drain screw side, as is shown in FIG. 7. The drivers 15′ and 16′ are oriented here opposed to one another in circumferential direction.

Purely theoretically, in the case of smaller forces which are to be transferred, also only radially elastic lugs can be provided, for example in the manner of the illustrated wings 15.

Observing the filter housing pot 2 according to FIGS. 2 to 4, it can be seen that the latter has a cylindrical sealing portion 17, in which the ring seal 12 of the lower disk 11 of the ring filter element 5 lies tightly, with the drain screw 9 situated in its lower position and in its intermediate position. Only with the drain screw 9 situated in its upper position are the ring filter element 5 and therefore also the lower end disk 11 raised so far that the ring seal 12 is pushed out from the cylindrical sealing portion 17.

In the lower end disk 11, of course openings are possible here for a water separation, so that separated water can arrive into the water collecting chamber 7 arranged beneath the end disk 11. With an adjusting of the drain screw 9 from its lower position into the intermediate position or from the intermediate position into its upper position, a screwing-in of the drain screw 9 into the filter housing pot 2 takes place.

Observing further FIGS. 1 to 6, it can be seen that the ring filter element 5 is connected with the filter housing pot 2 via a first thread 18. A dome 19, projecting concentrically and axially from the lower end disk 11 of the ring filter element 15 has here an external thread interrupted by clearances 20 (cf. FIG. 1), wherein at the same time spring elements 21 are provided projecting axially from the filter housing pot 2 and arranged hollow-cylindrically, at which spring elements respectively an internal thread portion is arranged which is configured in a complementary manner to the external thread, and wherein the external thread and the internal thread together form the first thread 18. Each internal thread portion extends here over a longer circumferential portion than a clearance 20, i.e. over a longer circular segment portion. Furthermore, the first thread 18 is configured in the opposite direction to the second thread 8 between the drain screw 9 and the filter housing pot 2.

The spring elements 21, owing to their at least slight radial elasticity, also enable an inserting of the ring filter element 5 into the filter housing pot 2 from above, because in this case the spring elements 21 are resilient simply elastically radially outwards. After interacting with the external thread at the dome 19, the spring elements 21 spring back radially inwards and form the first thread 18. To push the external thread over the internal thread, both threads have sliding surfaces 22.

Preferably, a total of eight spring elements 21 with respectively an internal thread portion are provided here. The external thread usually has a total of six clearances 20. The dome 19 and the external thread with its clearances 20 are preferably formed here in one piece with the lower end disk 11, in particular as a common plastic injection moulded part, but made possible through a manufacture which is, on the one hand, high quality and, on the other hand, favourably priced.

With the filter device 1 according to the invention, it is possible for the first time, in particular in the case of large ring filter elements 5, to exchange these more easily, because the drain screw 9 according to the invention is given a further function, namely that of the twisting, and thereby also the detaching, of the ring filter element 5 and of the pressing out of the latter from the filter housing pot 2.

The filter device 1 according to the invention can be configured here optionally as a suspended or as a standing filter, wherein it is configured as a suspended filter according to the illustrations in FIGS. 1 to 4. If it is configured as a standing filter, the first thread 18 could also be arranged between an upper end disk, not shown, of the ring filter element 5 and the cover 3.

1. A filter device comprising:
a filter housing pot and a ring filter element arranged therein;
the filter housing pot having a central drain channel in which a drain screw is arranged, the drain screw having a driver contour;
the ring filter element including a lower end disk having a ring seal lying on an outside and, in an installed state, interacting with the filter housing pot via a counter-driver contour interacting with the driver contour;
the drain screw adjustable between at least three positions including a lower position, an intermediate position, and an upper position;
wherein in the lower position the drain screw closes the drain channel;
wherein in the intermediate position the drain screw frees the drain channel and does not interact with the counter-driver contour on a ring filter element side via the driver contour;
wherein in the upper position the drain screw frees the drain channel and interacts with the counter-driver contour on the ring filter element side via the driver contour; and
wherein the drain screw and the ring filter element are configured such that a twisting of the drain screw twists the ring filter element.

2. The filter device according to claim 1, wherein:
the driver contour, on a drain screw side, includes at least two projecting wings; and
the counter-driver contour includes at least two stop elements structured and arranged to, in the upper position of the drain screw, interact with the at least two wings of the driver contour on the drain screw side.

3. The filter device according to claim 1, wherein:
the driver contour, on a drain screw side, includes at least two projecting wedge-shaped drivers; and
the counter-driver contour includes at least two likewise wedge-shaped drivers structured and arranged to in the upper position of the drain screw, interact with the at least two wedge-shaped drivers of the driver contour on the drain screw side.

4. The filter device according to claim 1, wherein the drain screw includes a screw ring seal which in the lower position of the drain screw is arranged in the drain channel.

5. The filter device according to claim 1, wherein the filter housing pot has a cylindrical sealing portion in which the ring seal of the lower end disk of the ring filter element is disposed when the drain screw is in the lower position and is in the intermediate position.

6. The filter device according to claim 1, wherein:
the ring filter element is coupled with the filter housing pot via a first thread;
the lower end disk includes a dome projecting centrically and axially therefrom with an external thread interrupted by a clearance, and the filter housing pot includes a plurality of spring elements projecting axially therefrom and arranged hollow-cylindrically, the plurality of spring elements respectively including an internal thread portion configured in a complementary manner to the external thread, the external thread and the internal thread together defining the first thread;
each internal thread portion extends over a longer circumferential portion than the clearance; and
the first thread is configured in an opposite direction to a second thread arranged between the filter housing pot and the drain screw.

7. The filter device according to claim 6, wherein the plurality of spring elements includes eight spring elements respectively including one internal thread portion.

8. The filter device according to claim 6, wherein the external thread defines six clearances.

9. The filter device according to claim 6, wherein the dome and the external thread with the clearance are a single, integral piece with the lower end disk.

10. The filter device according to claim 1, wherein the filter device is configured as one of a fuel filter and a lubricant filter.

11. A ring filter element for a filter device, comprising a lower end disc including a dome projecting centrically and axially therefrom with an external thread interrupted by a plurality of clearances, wherein the lower end disk includes an externally arranged ring seal.

12. The ring filter element according to claim 11, wherein the dome and the external thread with the plurality of clearances are a single, integral piece with the lower end disk.

13. The filter device according to claim 2, wherein the at least two wings project at least one of axially and radially from the driver contour.

14. The filter device according to claim 3, wherein the at least two wedge-shaped drivers project axially from the driver contour.

15. The filter device according to claim 6, wherein:
the driver contour, on a drain screw side, includes at least two projecting wings; and
the counter-driver contour includes at least two stop elements structured and arranged to, in the upper position of the drain screw, interact with the at least two wings of the driver contour on the drain screw side.

16. The filter device according to claim 6, wherein:
the driver contour, on a drain screw side, includes at least two projecting wedge-shaped drivers; and
the counter-driver contour includes at least two likewise wedge-shaped drivers structured and arranged to, in the upper position of the drain screw, interact with the at least two wedge-shaped drivers of the driver contour on the drain screw side.

17. The filter device according to claim 6, wherein the drain screw includes a screw ring seal which in the lower position of the drain screw is arranged in the drain channel.

18. The filter device according to claim 6, wherein the filter housing pot has a cylindrical sealing portion in which the ring seal of the lower end disk of the ring filter element is disposed when the drain screw is in the lower position and in the intermediate position.

19. A filter device comprising:
a filter housing pot and a ring filter element arranged therein;
the filter housing pot having a cylindrical sealing portion and a central drain channel in which a drain screw is arranged, the drain screw having a driver contour and a screw ring seal;
the ring filter element including a lower end disk having a ring seal lying on an outside and, in an installed state, interacting with the filter housing pot via a counter-driver contour interacting with the driver contour;
the drain screw adjustable between at least three positions including a lower position, an intermediate position, and an upper position;
wherein in the lower position the drain screw closes the drain channel, the screw ring seal is arranged in the drain channel, and the ring seal of the lower end disk is disposed in the cylindrical sealing portion;
wherein in the intermediate position the drain screw frees the drain channel and does not interact with the counter-driver contour on a ring filter element side via the driver contour, and the ring seal of the lower end disk is disposed in the cylindrical sealing portion;
wherein in the upper position the drain screw frees the drain channel and interacts with the counter-driver contour on the ring filter element side via the driver contour; and
wherein the drain screw and the ring filter element are configured such that a twisting of the drain screw twists the ring filter element.

20. The filter device according to claim 19, wherein:
the lower end disk includes a dome projecting centrically and axially therefrom, the dome including an external helical thread defining a clearance;
the filter housing pot includes a plurality of spring elements projecting axially therefrom structured hollow-cylindrically, the plurality of spring elements respectively including an internal thread portion structured complementary to the external thread and extending over a longer circumferential portion than clearance;
the external thread and the internal thread together defining a first thread via which the ring filter element and the filter housing pot are coupled together; and
a second thread between the filter housing pot and the drain screw is configured in an opposite direction of the first thread.
